(19) United States
(12) Patent Application Publication
(10) Pub. No.: US 2008/0318120 A1
(43) Pub. Date: Dec. 25, 2008

(54) Power storage unit

(75) Inventor: Yoshiyuki Nakamura, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/213,347

(22) Filed: Jun. 18, 2008

(30) Foreign Application Priority Data
Jun. 20, 2007 (JP) 2007-162601

(51) Int. Cl. H01M 2/10; H01M 6/42

(52) U.S. Cl. 429/99; 429/149

(57) ABSTRACT

A power storage unit has: a plurality of power storage modules each constituted of a power generation element and a power-generation-element-case containing the power generation element and disposed adjacent to each other, and a case containing the power storage modules and an insulative fluid. At least one groove is formed at the power-generation-element-case of each power storage module such that the power-generation-element-case breaks at the groove in response to an excessive increase in the pressure in the power-generation-element-case. The groove is formed in a portion of the power-generation-element-case that does not face any other power storage module.

### INCORPORATION BY REFERENCE

The disclosure of Japanese Patent Application No. 2007-162601 filed on Jun. 20, 2007 including the specification, drawings and abstract is incorporated herein by reference in its entirety.

### BACKGROUND OF THE INVENTION

1. Field of the Invention

The invention relates to a power storage unit having a plurality of power storage modules each constituted of a power generation element and a case containing the power generation element and having at least one groove at its wall.

2. Description of the Related Art

In a secondary battery constituted of a power generation element and a case containing the power generation element, gas is produced from the power generation element due to excessive charging, and so on, and such gas increases the internal pressure of the case excessively.

Japanese Utility Model Application Publication No. 06-21172 (JP-Y-06-21172) (e.g., FIG. 1) discloses a secondary battery having a case on which a groove is formed so that the wall thickness of the case is smaller at the groove than at other portions. When the pressure in the case increases excessively due to gas production therein, the case of the secondary battery cracks at the groove, whereby the gas is released from the case to the outside.

In the following, a description will be made of a case where a battery assembly is constituted of a plurality of the secondary batteries disclosed in JP-Y-06-21172.

According to this battery assembly, when the case of one of the secondary batteries breaks at the groove in response to an excessive increase in the pressure in said case, it deforms outwardly. At this time, part of the deforming case may contact the adjacent secondary battery. In particular, if the interval between the two adjacent batteries is small, the possibility of such contact is high.

Conversely, if the interval between the two adjacent secondary batteries is large, the deforming part of the case does not contact the adjacent secondary battery.

However, the larger the interval between each adjacent secondary batteries, the larger the battery pack constituted of a number of secondary batteries becomes inevitably, which is undesirable.

### SUMMARY OF THE INVENTION

An aspect of the invention relates to a power storage unit, having: a plurality of power storage modules each constituted of a power generation element and a power-generation-element-case containing the power generation element and disposed adjacent to each other, and a case containing the power storage modules and an insulative fluid, wherein at least one groove is formed at the power-generation-element-case of each power storage module such that the power-generation-element-case breaks at the groove in response to an excessive increase in the pressure in the power-generation-element-case, the groove being formed in a portion of the power-generation-element-case that does not face other power storage module.

According to the power storage unit described above, even if the power-generation-element-case of the power storage module breaks and deforms, it does not contact any other power storage module, and thus the power storage modules can be arranged close to each other to make the power storage unit more compact in size.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is an exploded perspective view of a battery pack according to the first example embodiment of the invention;

FIG. 2A is a perspective view showing the exterior of the battery cell of the first example embodiment;

FIG. 2B is a cross-sectional view of the battery cell of the first example embodiment;

FIG. 3 is a schematic cross-sectional view of the battery pack of the first example embodiment;

FIG. 4A is a view illustrating the position of the groove at a battery cell; and

FIG. 4B is a view illustrating the position of the groove at another battery cell.

### DETAILED DESCRIPTION OF THE EMBODIMENTS

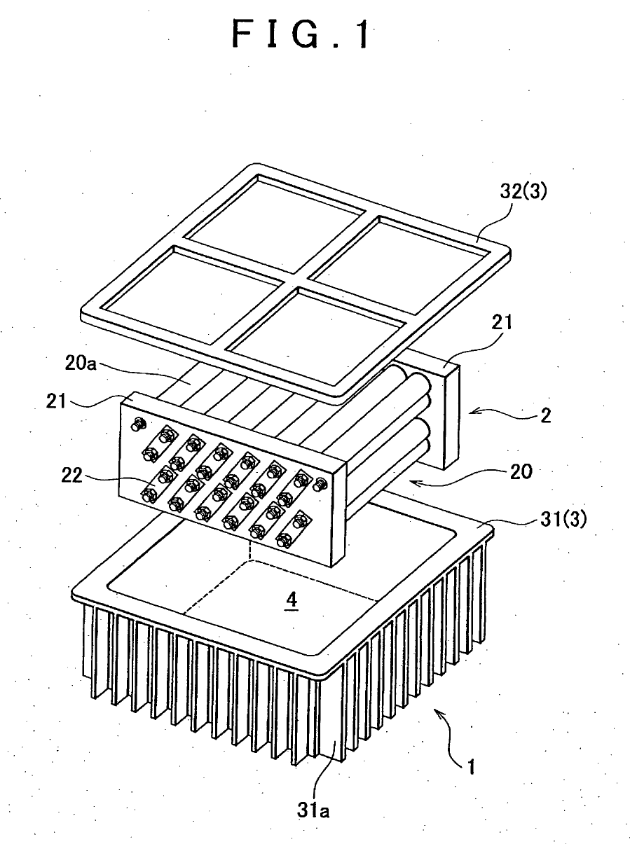

The structure of a battery pack 1 (power storage unit) according to the first example embodiment of the invention will be described with reference to FIG. 1. FIG. 1 is an exploded perspective view of the battery pack 1. The battery pack 1 is mounted in a vehicle.

The battery pack 1 is constituted of a pack case 3 (“case”), a power storage assembly 2 stored in the pack case 3, and coolant 4.

The pack case 3 is constituted of a case member 31 defining a space for storing the power storage assembly 2 and the coolant 4 and a lid member 32. The lid member 32 is fixed on the case member 31 using fasteners, such as bolts (not shown in the drawings), or by welding, or the like, whereby the inside of the pack case 3 is hermitically sealed

The case member 31 is fixed to a vehicle body member (not shown in the drawings) using fasteners, such as bolts, (not shown in the drawings), or by welding, or the like. Thus, the bottom face of the pack case 3 is in contact with the surface of the vehicle body member. The vehicle body member is, for example, a floor panel, a floor pan, or a vehicle body frame.

Provided on the outer face of the pack case 3 are radiation fins 31a for improving the radiation performance of the battery pack 1. Note that the case member 31a may be omitted if appropriate. Preferably, the case member 31 and the lid member 32 are made of a material having a high durability and a high corrosion resistance, such as aluminum.

The power storage assembly 2 is constituted of the battery assembly 20 composed of a plurality of battery cells 20a (“power storage modules”) and two support members 21 supporting the battery cells 20a (i.e., the longitudinal ends of each battery cell 20a). Each battery cell 20a is electrically, and mechanically, connected to the adjacent battery cell 20a via a bus bar 22 such that the battery cells 20a are electrically connected in series via the bus bars 22. Through this series connection, the power storage unit 2 produces a high output (e.g., 200 V).

One end of a positive cable and one end of a negative cable (not shown in the drawings) are connected to the battery assembly 20, and the other ends of these cables are connected to electric devices (e.g., a motor for propelling the vehicle) provided outside of the pack case 3.

In this example embodiment of the invention, cylindrical secondary batteries are used as the battery cells 20a. These batteries are, for example, nickel-hydrogen batteries or lithium-ion batteries. The battery cells 20a are not necessarily cylindrical, but they may instead be rectangular. Further, while secondary batteries are used as the battery cells 20a in this example embodiment of the invention, electric double-layer capacitors (condensers) may alternatively be used as the battery cells 20a.

The coolant 4 in the pack case 3 is in contact with the outer faces of the battery assembly 20 (the battery cells 20a) and the inner faces of the pack case 3. Being in contact with the battery assembly 20, the coolant 4 absorbs the heat of the battery assembly 20 produced through its charging and discharging and thus suppresses an increase in the temperature of the battery assembly 20. Having absorbed the heat of the battery assembly 20, the coolant 4 moves in the pack case 3 due to natural convection and thus contacts the inner faces of the pack case 3, whereby the heat of the coolant is transferred to the pack case 3. The heat transferred to the pack case 3 is radiated to the outside (atmosphere) or transferred to the vehicle body member in contact with the pack case 3.

While the battery pack 1 is structured to cause the natural convection of the coolant 4 in the pack case 3 by temperature differences, the natural convection of the coolant 4 may be caused otherwise. For example, an agitating member (i.e., fan) for forcibly causing the coolant 4 to flow may be provided in the pack case 3.

For example, the coolant 4 may be selected from among various insulative oils or inactive fluids. The insulative oils include silicon oils, and the inactive fluids include fluorine inactive fluids, such as Fluorinert, NovecHFE (hydrofluoroether) and Novec1230 (Product of Minnesota Mining & Manufacturing Co. (3M)).

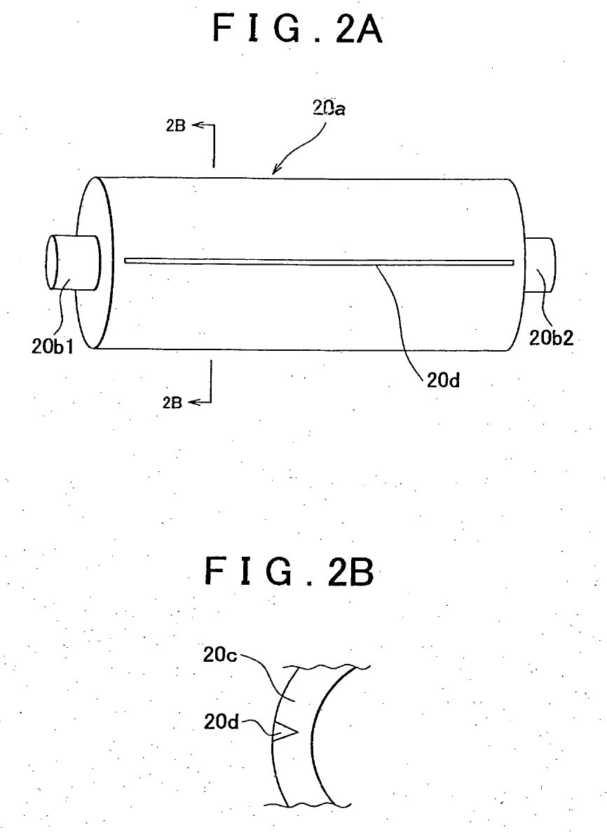

Next, the structure of each battery cell 20a will be described in detail with reference to FIG. 2A and FIG. 2B. FIG. 2A is a perspective view showing the exterior of the battery cell 20a, and FIG. 2B is a cross-sectional view showing a region of a cross section taken along the line 2B-2B in FIG. 2A, which is where the later-described groove is formed.

A positive terminal 20b1 and a negative terminal 20b2 are provided at the respective longitudinal ends of the battery cell 20a. The terminals 20b1, 20b2 of the adjacent battery cells 20a are electrically connected to each other via the bus bars 22.

Each battery cell 20a is constituted of a power generation element (not shown in the drawings) and a battery case 20c (“power-generation-element-case”) containing the power generation element. The power generation element is constituted of a positive electrode, a negative electrode, and electrolytic solution, and power is charged to and discharged from the power generation element.

In the case where nickel-hydrogen batteries are used as the battery cells 20a, for example, the active material on the collector of the positive electrode is nickel oxide, and the active material on the collector of the negative electrode is hydrogen adsorption alloy, which is, for example, MmNi(_{5-x-y-z)}AlₓMn_{y}Co_{z} (Mm: misch metal), and the electronic solution is potassium hydroxide.

On the other hand, in the case where lithium-ion batteries are used as the battery cells 20a, for example, the active material on the collector of the positive electrode member is lithium-transition metal composite oxide, and the active material on the collector of the negative electrode is carbon, and the electronic solution is an organic electronic solution.

Meanwhile, a groove 20d is formed in the outer peripheral face of the battery case 20c of each battery cell 20a. The groove 20d extends in the longitudinal direction of the battery cell 20a. Referring to FIG. 2B, the width of the groove 20d is largest at the outer face, and it gradually decreases toward the inner side in the radial direction of the battery cell 20a. As such, the thickness of the battery case 20c is smaller at the groove 20d than at other portions. That is, the mechanical strength of the portion where the groove 20d is formed is lower than that of other portions of the battery case 20c.

When the pressure in the battery case 20c exceeds a certain level, the battery case 20c breaks at the groove 20d, so that gas is released from the battery cell 20a. At this time, the speed at which the gas is released from the battery case 20c is relatively low for the following reason. That is, because the groove 20d is formed in a side face of the battery case 20c, it is longer than when it is formed in an end face of the battery case 20c where the positive terminal 20b1 or the negative terminal 20b2 is provided.

In other words, when the groove 20d is formed in a side face of the battery case 20c, the area of the opening through which gas is released from the battery cell 20a is relatively large and thus the gas release speed is relatively low as compared to when the groove 20d is formed in an end dace of the battery case 20c. The lower the gas release speed, the lower the load imposed on the pack case 3 when the gas is being released from the battery cell 20a, and the lower the load on the pack case 3, the simpler the structure of the pack case 3 can be made.

Note that the cross-sectional shape of the groove 20d is not limited to that shown in FIG. 2B, but it may be shaped otherwise. That is, the groove 20d can be formed in any shape as long as the thickness of the battery case 20c is smaller at the groove 20d than at other portions.

Thus, the groove 20d serves as a valve (a breaker valve) to open the battery case 20c when the pressure in the battery cell 20a (the battery case 20c) increases excessively. Note that breaker valves are valves that irreversibly switches from “closed state” to “open state”.

For example, when the battery cell 20a has been overcharged, gas may be produced from the power generation element in said battery cell 20a. In this case, the gas increases the pressure in the battery cell 20a. When the pressure in the battery cell 20a reaches a certain level, the battery case 20c breaks at the groove 20d, whereby the gas produced from the power generation element is released to the outside.

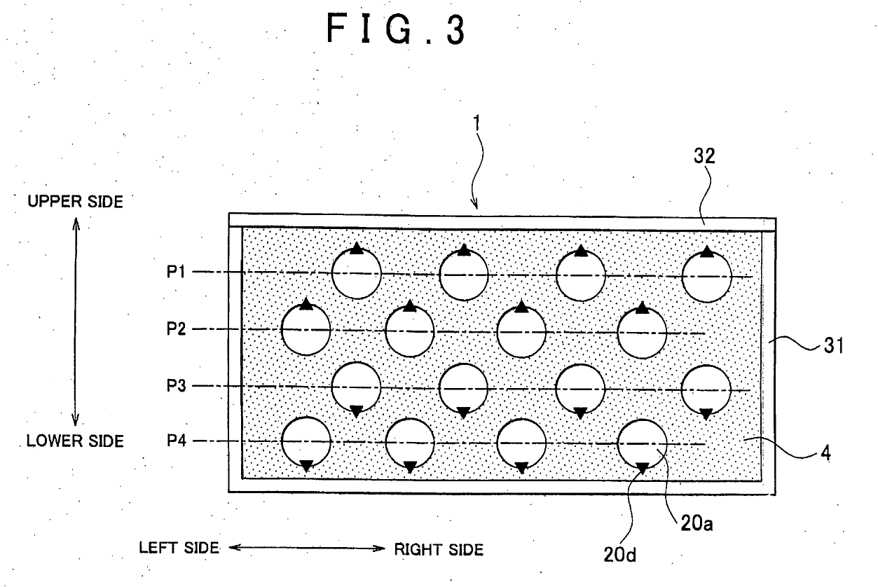

Next, with reference to FIG. 3, a description will be made of the position of the groove 20d at the battery case 20c of each battery cell 20a of the battery assembly 20. FIG. 3 is a schematic cross-sectional view of the battery pack 1, illustrating the positional relation between the grooves 20a of the respective battery cells 20a. In FIG. 3, the triangle black indexes represent the positions of the respective grooves 20d. The apexes of these indexes represent the directions the respective grooves 20d face.

The battery cells 20a are arranged adjacent to each other on planes P1 to P4, respectively. While FIG. 3 shows that the adjacent battery cells 20a are spaced apart from each other, they are actually close to each other. Note that the adjacent battery cells 20a are not in contact with each other. Note that the planes P1 to P4 may be regarded as examples of “predetermined plane” in the invention.

At the battery cells 20a arranged on the planes P1 and P2, the grooves 20d are formed in the upper sides of the respective battery cells 20a. Each battery cell 20a on the plane P2 is disposed at the position facing the space between the corresponding two battery cells 20a on the plane P1. That is, the battery cells 20a on the plane P1 and the battery cells 20a on the plane P2 are staggered in the direction perpendicular to the direction of gravity (the horizontal direction of FIG. 3).

On the other hand, at the battery cells 20a arranged on the planes P3 and P4, the groove 20d are formed in the lower sides of the respective battery cells 20a. Each battery cell 20a on the plane P3 is arranged at the position facing the space between the corresponding two battery cells 20a on the plane P4. That is, the battery cells 20a on the plane P3 and the battery cells 20a on the plane P4 are staggered in the direction perpendicular to the direction of gravity (the horizontal direction of FIG. 3).

The battery cells 20a on the plane P1 and the battery cells 20a on the plane P3 face each other in the direction of gravity, and the battery cells 20a on the plane P2 and the battery cells 20a on the plane P4 face each other in the direction of gravity.

While the battery cells 20a are arranged on the four planes P1 to P4 in the structure illustrated in FIG. 3, they may be arranged otherwise. For example, the number of planes on which the battery cells 20a are arranged adjacent to each other may be set to any number. Further, while the battery cells 20a on the respective planes P1 to P4 are staggered in the direction perpendicular to the direction of gravity, they may be arranged otherwise. For example, the battery cells 20a on the respective planes P1 to P4 may be aligned in the direction of gravity.

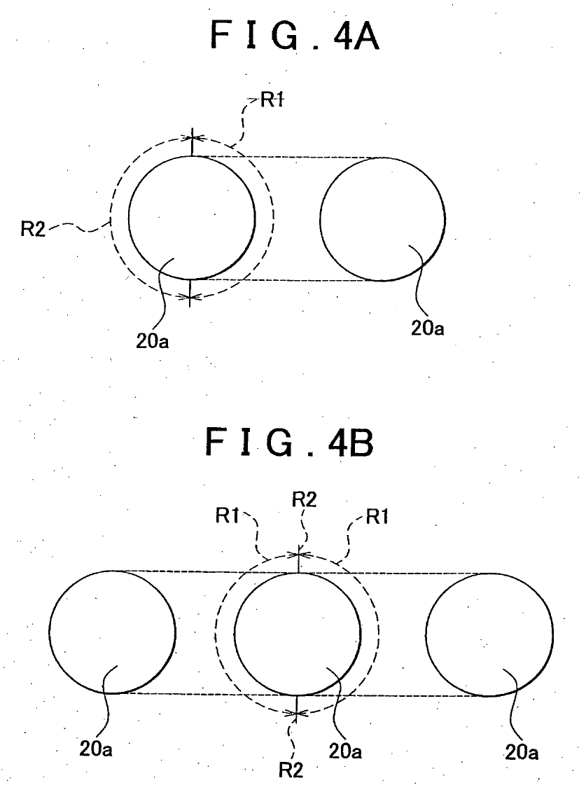

Next, the principal for determining the position of the groove 20d at each battery cell 20a will be described with reference to FIG. 4A and FIG. 4B.

FIG. 4A illustrates the relation between two adjacent battery cells 20a on a given plane (e.g., any of the planes P1 to P4). Referring to FIG. 4A, “R1” represents the region of the outer peripheral face of the battery cell 20a that faces the adjacent battery cell 20a, and “R2” represents other region. That is, the region R2 is a region not facing the adjacent battery cell 20a.

The groove 20d is formed in the region R2. If the groove 20d is formed in the region R1, the battery cell 20a may contact the adjacent battery cell 20a when the battery case 20c breaks at the groove 20d. That is, when the battery case 30c breaks at the groove 20d, the portion where the groove 20d is formed deforms radially toward the outer side and then contacts the adjacent battery cell 20a.

On the other hand, if the groove 20d is formed in the region R2, when the battery case 20c breaks at the groove 20d, it does not contact the adjacent battery cell 20a.

Next, FIG. 4 illustrates a case where three battery cells 20a are arranged on a given plane so that one battery cell 20a is located between other two battery cells 20a on both sides.

The most part of the outer peripheral face of the center battery cell 20a among the three battery cells 20a is occupied by the regions R1. In this case, the regions R2 are the boundaries between the region R1 facing the adjacent battery cell 20a on the right side and the region R1 facing the adjacent battery cell 20a on the left side. Thus, grooves 20d are formed in the respective regions R2 at the boundaries between the two regions R1.

According to the structure described above, even if the battery case 20c of the center battery cell 20a breaks at the grooves 20d, it does not contact the adjacent battery cells 20a on both sides.

That is, the positions of the battery cells 20a on the planes P1 to P4 are determined based on the principal described above with reference to FIG. 4A and FIG. 4B.

Meanwhile, in the structure shown in FIG. 3, the grooves 20d of the battery cells 20a facing each other in the direction of gravity are arranged such that their battery cases 20c break in the opposite directions. When the battery case 20c of the lower battery cell 20a of the two battery cells 20a facing each other in the direction gravity breaks at the groove 20d, gas is released from the lower battery cell 20a and the gas then moves upward (in the direction opposite to the direction of gravity) and contacts the upper battery cell 20a.

In this case, if the groove 20d of the lower battery cell 20a is formed on the side where the upper battery cell 20a is present, the released gas easily reaches the upper battery cell 20a. Because the temperature of the gas released from the lower battery cell 20a is high, the upper battery cell 20a is heated by this gas. At this time, gas may be produced also in the upper battery cell 20a depending upon the extent to which the upper battery cell 20a is heated by the released gas.

Meanwhile, in the structure of the example embodiment of the invention, because the grooves 20d of each two battery cells 20a facing each other in the direction of gravity are arranged such that their battery cases 20c break in the opposite directions, when gas is released from the lower battery cell 20a, the gas needs to move a longer distance before reaching the upper battery cell 20a. That is, the distance the released gas moves in the coolant 4 is relatively long, and thus the time the released gas remains in contact with the coolant 4 is relatively long.

The longer the released gas remains in contact with the coolant 4, the more efficiently the gas can be cooled. Therefore, even if the released gas contacts the upper battery cell 20a, the upper battery cell is not heated excessively by the released gas, and thus the aforementioned gas production in the upper battery cell due to heating can be prevented.

The above-described arrangement of the grooves 20d in the respective battery cells 20a allows the battery cells 20a to be located close to each other while ensuring that, when the battery case 20c of any battery cell 20a deforms due to gas production therein, a part of said case does not contact the adjacent battery cell 20a. Thus, by arranging the battery cells 20a close to each other, the battery pack 1 can be made compact in size.

All the battery cells 20a of the battery assembly 20 have the common structure shown in FIG. 2A and FIG. 2B. Thus, when attaching the battery cells 20a to the support members 21, the positions of the respective grooves 20d can be changed by rotating the battery cells 20a.

While each groove 20d is formed so as to in the longitudinal direction of the battery cell 20a, they may be formed otherwise. That is, the direction of each groove 20d may be changed as needed. Further, two or more grooves 20d may be formed on each battery cell 20a.

However, in a case where two or more grooves 20d are formed on each battery cell 20a or in a case where a single groove 20d is formed at each battery cell 20a so as to extend in the circumferential direction of the battery cell 20a, the region of the groove 20d in the circumferential direction of the battery cell 20a is larger than when a single groove 20d is formed at each battery cell 20a so as to extend in the longitudinal direction of the battery cell 20a. In this case, therefore, the groove or grooves 20d may overreach the boundaries of the region R2.

For this reason, preferably, each groove 20d is formed so as to extend in the longitudinal direction of the battery cell 20a. This structure minimizes the region of the groove 20d in the circumferential direction of the battery cell 20a.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

What is claimed is:

1. A power storage unit, comprising:
a plurality of power storage modules each constituted of a power generation element and a power-generation-element-case containing the power generation element and disposed adjacent to each other, and
a case containing the power storage modules and an insulative fluid, wherein
at least one groove is formed at the power-generation-element-case of each power storage module such that the power-generation-element-case breaks at the groove in response to an excessive increase in the pressure in the power-generation-element-case, the groove being formed in a portion of the power-generation-element-case that does not face any other power storage module.

2. The power storage unit according to claim 1, wherein:
the power storage modules include a first power storage module and a second power storage module that is located below the first power storage module in the direction of gravity; and
the groove of the power-generation-element-case of the second power storage module is positioned such that the power-generation-element-case of the second power storage module breaks downward in the direction of gravity in response to an excessive increase in the pressure in the power-generation-element-case of the second power storage module.

3. The power storage unit according to claim 1, wherein:
the power storage modules include a first power storage module and a second power storage module that is located below the first power storage module along the direction of gravity; and
the groove of the power-generation-element-case of the first power storage module is positioned such that the power-generation-element-case of the first power storage module breaks upward in a direction opposite to the direction of gravity in response to an excessive increase in the pressure in the power-generation-element-case of the first power storage module.

4. The power storage unit according to claim 1, wherein the power storage modules are arranged adjacent to each other on a plane.

5. The power storage unit according to claim 4, wherein the power storage modules are arranged on a plurality of planes.

6. The power storage unit according to claim 5, wherein the power storage modules on one of the planes and the power storage modules on the other of the planes are staggered in a direction perpendicular to the direction of gravity.

7. The power storage unit according to claim 1, wherein the power storage modules are arranged close to but not in contact with each other.

8. The power storage unit according to claim 1, wherein the portion of the power-generation-element-case that does not face any other power storage module is a portion of the power-generation-element-case that does not contact any other power storage module when the power-generation-element-case breaks at the groove and deforms in response to an excessive increase in the pressure in the power storage module.

9. The power storage unit according to claim 1, wherein the groove of the power-generation-element-case of each power storage module extends in the longitudinal direction of the power storage module.

10. The power storage unit according to claim 1, wherein
the cross-sectional shape of each power storage module on a plane perpendicular to the longitudinal direction of the power storage module is generally circular.

11. The power storage unit according to claim 10, further comprising a support member on which longitudinal ends of the power storage modules are supported such that the power storage modules can rotate on the support member.

12. The power storage unit according to claim 1, wherein the width of the groove of the power-generation-element-case of each power storage module is largest at the outer face of the power-generation-element-case and gradually decreases toward the inner side in the radial direction of the power storage module.

13. The power storage unit according claim 1, wherein the power storage unit is mounted in a vehicle.
